(19) United States
(12) Patent Application Publication
(10) Pub. No.: US 2016/0043892 A1
(43) Pub. Date: Feb. 11, 2016

(54) SYSTEM AND METHOD FOR CLOUD BASED PROVISIONING, CONFIGURING, AND OPERATING MANAGEMENT TOOLS

(71) Applicant: INTIGUA, INC., Newton, MA (US)

(72) Inventors: Shimon HASON, Brookline, MA (US); Shai TOREN, Alonei Aba (IL); Oran EPELBAUM, Givat Shmuel (IL)

(21) Appl. No.: 14/805,711

(22) Filed: Jul. 22, 2015

Related U.S. Application Data
(60) Provisional application No. 62/027,331, filed on Jul. 22, 2014.

(51) Int. Cl. H04L 12/24; H04L 12/26; H04L 29/08

(52) U.S. Cl. CPC H04L 41/046; H04L 67/34; H04L 43/08

(57) ABSTRACT

A system and method for providing a service may include creating a management tool backend server. A management unit may be installed on a management tool backend server. A request to provide a management service may be received and the management unit and a plurality of management agents installed in a plurality of endpoint servers may be caused to provide the management service.

### CROSS REFERENCE TO RELATED APPLICATIONS

This application claims the benefit of U.S. Provisional Application Ser. No. 62/027,331, filed Jul. 22, 2014, which is hereby incorporated by reference in its entirety.

### FIELD OF THE INVENTION

The present invention relates generally to management tools. More specifically, the present invention relates to providing management services.

### BACKGROUND OF THE INVENTION

Enterprises Information Technology (IT) personnel engage in building and operating business applications for their enterprise using servers (endpoint servers) in their computing infrastructure. To ensure these applications are correctly deployed and meet operational standards in terms of security, integrity, robustness and regulatory compliance, IT groups use management tools.

Examples of management tools are: monitoring tools such as HP Operations Manager, configuration management tools such as Microsoft System Center Configuration Manager, backup tools such as Symantec Netbackup, and security and auditing tools such as Tenable LCE and Symantec Endpoint Protection.

Each of these management tools is often made up of a server side, composed of one or multiple servers in some form of computer cluster (backend cluster), which form the central part of the management tools' deployment and provides centralized management and access to users.

In addition, many of these management tools have agents—software which needs to be installed on every endpoint server. For each of these management tools, the agents and backend cluster work together to achieve its management functionality.

Enterprise-grade management products such as in the examples above are hard to deploy and manage by organizations throughout their lifecycle, due to several challenges, such as: the need to deploy, manage, and scale the backend clusters, the need to ensure the availability of the backend clusters and handle faults, having to deploy multiple sets of backend clusters across different data centers, geographical locations, etc.

Other difficulties arise due to: the need to deploy and manage agents on endpoint servers, the need to ensure that each agent is configured to work with the correct backend cluster and succeeds in forming a communication link to it and in authenticating its identity if needed, and the need to ensure that each backend cluster applies correct configuration to individual endpoint servers and the agents installed on them and communicating with the backend cluster.

Yet other challenges or difficulties may be attributed to: the need to occasionally upgrade the backend clusters' software, while maintaining their functionality while the upgrade is taking place, the need to occasionally upgrade the agent software on each endpoint server, the need to ensure that such upgrades do not cause incompatibility, the need to ensure that agents do not fail, and to recover them in case of failure and the need to ensure agents do not cause adverse effects to other software running on endpoint servers, e.g. by through exhausting the endpoint server's memory, CPU or i/o resources, or by leaving scraps of software and data lying around the endpoint server's file system or registry after the agent has been removed or upgraded.

Reference is made to FIG. 1, which depicts a typical case of management tools deployment and maintenance. As shown, one or more users within the IT group (block 1.1) have to install and access (arrow 1.4) one or more backend cluster servers (block 1.16) for each management tool, and install, configure and connect together the software for the management tool's backend cluster (block 1.5).

In addition, IT users need to access (arrow 1.2) each endpoint server (block 1.3) that needs to be managed with the management tool (block 1.5), possibly through direct network access with protocols such as SSH (arrow 1.2), in order to install and configure a management tool agent (block 1.6). In addition, the need to ensure that the agent and the backend cluster servers succeed in communicating with one another (arrow 1.7), and do this for as long as the endpoint server needs to be managed, which is typically its entire lifetime.

A similar process of accessing (arrow 1.13) each of the management tool backend cluster servers (block 1.16) and endpoint servers (block 1.3) may have to be repeated whenever the management tool configuration needs to change, and when the management tool software on the backend cluster side (block 1.5) or the agent side (block 1.6) needs to be upgraded or removed. In order to operate the management tool, for instance to initiate a backup operation for a backup tool such as Symantec NetBackup, the user must locate and operate the correct management tool backend cluster software (block 1.5) on the correct backend cluster server (block 1.16). This may be difficult as multiple instances of the management cluster software may exist within an organization, and as each management tool has different user interfaces (UIs) and application programming interfaces (APIs), and different access control settings.

### SUMMARY OF THE INVENTION

A system and method for providing a service may include creating a management tool backend server. A management unit may be installed on a management tool backend server. A request to provide a management service may be received, and the management unit and a plurality of management agents installed in a plurality of endpoint servers may be caused to provide the management service.

A plurality of management tool backend servers may be caused to provide a management service. A plurality of management tools on a respective plurality of management tool backend servers may provide a single management service. A management tool backend server may be selected to provide a management service based on at least one of: a cost, an attribute of an endpoint server, a network topology and a geographic location.

Services that may be provided for an endpoint server may be identified based on at least one of: a related management tool backend server, a tag of the endpoint server, a function performed by the endpoint server, a cost, a geographic location, a network topology and an operating system type.

A management tool backend server may be created upon receiving a management service request. A status of at least one of: the management tool backend server, the management unit, the management agents and the endpoint servers may be periodically determined, and an action may be taken based on the status. A management unit may be configured to balance load between a plurality of management tool backend servers. A management unit in a first management tool backend server may be replicated on, or copied to, a second management tool backend server. A management unit may apply a change to an attribute of the management service based on input from a user.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 depicts a typical case of management tools deployment according to the prior art;

FIG. 2 is a schematic illustration of a system and method according to one embodiment of the present invention;

FIG. 3 is a high level block diagram of a system and method according to some embodiments of the present invention;

FIG. 4 is a high level block diagram of a system and method according to some embodiments of the present invention;

FIG. 5 is a high level block diagram of a computing device according to one embodiment of the present invention; and

FIG. 6 is a block diagram of an exemplary method or flow according to embodiments of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

A system and method according to some embodiments of the invention may allow enterprises to use enterprise-grade management products without having to worry about all the concerns, or going through the steps involved in, deploying, maintaining and managing management tools, e.g., as described in the background. A system and method according to some embodiments of the invention may, for example, by autonomously and automatically providing and managing management services as described herein, improve application performance, reduce risk due to lack of sufficient management, and improve organizational agility and focus.

Some embodiments of the invention may include or provide an internet-based Application Program Interface (API) for provisioning, configuring, and operating management tools. Using an API provided by a system and method according to some embodiments of the invention, a user may be relieved of tasks such as installation of backend clusters within the enterprise and/or install agents on endpoint servers.

As described, in some embodiments, users can use an API and additional user interfaces which use the API as a way of consuming any third-party management tool in the form of a management service. Consuming a management tool in the form of a management service may include including services provided by the management tool in services provided by the management service.

In some embodiments, a management service may be an instance or multiple instances of a management tool deployment, which is provided to users in an easily-consumed service form, thus relieving user from having to go through the problems associated with operating or managing management tools as described in detail above.

In some embodiments, the centralized portion of each management service may be implemented by creating a pre-installed set of (potentially multi-tenant) backend clusters.

In some embodiments, the centralized portion of each management service may be implemented by automatically deploying backend servers or clusters of backend servers, in the user's computing infrastructure or in an external computing infrastructure as needed.

In some embodiments, the same set of backend cluster servers is shared between different users from different organizations (multi-tenant). Multi-tenant servers are known in the art and generally are servers serving users from different organizations (tenants) without allowing users from one tenant to see or access any information related to other tenants. User's interactions with the implementation may be validated against an access control list (ACL) of allowed resources within the backend cluster, or through a pattern-matching algorithm, to enforce multi-tenancy security and deny one user access to another users' data on the same backend cluster.

In some embodiments, configuration of the backend cluster servers and the management tool backend cluster software installed on them is done by a system or method according to some embodiments of the invention through modification of configuration files and registry settings on the backend cluster servers.

In some embodiments, configuration of backend cluster servers is done using configuration management tools such as Puppet. Configuration management tools, which need to be used on backend cluster servers, may themselves be consumed as management tools by a system or method according to some embodiments of the invention.

In some embodiments, backend clusters are extended to include, in addition to servers running management tool backend software, also servers and network equipment providing enhanced capabilities such as load balancing, distributed database, backup, high availability, disaster recovery, etc.

In some embodiments, the agent portion of a management service may be implemented by installing agents on demand or by deploying virtual agents. Virtual agents may be agents that run inside a container used to cleanly isolate them from applications running on the same endpoint server, for example as described in detail in U.S. patent application Ser. No. 13/572,740, titled SYSTEM AND METHODS FOR MANAGEMENT VIRTUALIZATION, (U.S. Patent Application Publication No. 2014/0047439) incorporated herein by reference.

Some embodiments of the invention may include or provide an API usable by both users (typically enterprise IT groups), and management tools vendors, who may wish to provide users with an ability to use their management tools without having to go through the issues described above.

Portions of an API provided or used by some embodiments of the invention may apply to both types of users. For example, a portion of an API targeted mainly at users may include functionality such as:
Creating and providing a List of available management services, either with or without exposing the management tools which the management services wrap, include or execute;
Finding management services serving certain needed functionality (e.g. backup) in a certain Service Level Agreement (SLA), and matching other conditions such as price, availability in certain geographies, and availability for specific endpoint server characteristics such as operating system;
Configuring a management service with a configuration suitable to the need of the user's organization;
Configuring a service encompassing multiple geographical or network zones, as a single service using different underlying backend clusters;
Associating a management service with an endpoint server, in a user-defined configuration. This may cause the management tool to start operating on the endpoint server, including installation of the agents if needed, configuration of a cloud-based backend cluster, and connecting the endpoint server and backend cluster;
De-associating a management service from an endpoint server, possibly resulting in a removal of the endpoint and any associated agent from any listing or configuration within the backend cluster, and in removal of an agent from the endpoint server;
Changing a configuration of a management service on an endpoint server, possibly resulting in changes being made automatically to both the backend cluster and the agent configuration;
Defining (e.g., using a programming language) health tests which may be applied regularly, or one time, to management tool agents and backend clusters, and corrective or notification actions to be taken upon success or failure;
Querying for information related to a management service associated with a particular endpoint server. Such information may include health status, operational metrics, and success/failure indication for management activities carried out, as well as implementation details related to the tool and configuration being used to provide the management service;
Performing management tasks offered by a management service on particular endpoint servers, e.g., initiating a backup operation by invoking a “backup” operation in the management service. Such tasks may be delegated to underlying interfaces of the management tools underlying the management services; and
Adding custom functionality to management services, which may run on either the endpoint server, backend cluster or both, define by software code.

A portion of an API targeted mainly at management tools vendors may include functionality such as:
Registering a management tool with a system that provides management services;
Describing (e.g., in the form of software code or configuration information) how a management tool is to be encapsulated or included in a management service, both on the backend cluster side and on the agent side. A definition may include how both parts of the service (agent and backend cluster) can be automatically set up, configured, monitored for health, removed, or be used to provide management capabilities such as backup or server monitoring; and
Configuring a service encompassing multiple types of endpoint servers, e.g. with different operating systems or in different geographical locations, as a single service using different underlying agents.

In some embodiments, an API is made available to other systems through a Representational State Transfer (REST) interface using HTTP or HTTPS as known in the art. Accordingly, a system and method according to some embodiments of the invention may be used with any third-party management system.

A user interface (UI) may be provided for delivering part, or the entire set of API functionalities to human users using a regular computer or mobile device connected to the enterprise network or to the Internet. In some embodiments, a UI is accessed through a web browser such as Google Chrome, possibly by running JavaScript code, which in turn uses the API as known in the art.

In some embodiments, management services may be categorized into generic categories such as backup, monitoring, security auditing, etc. Categories of management services may be presented to a user thus helping or guiding a user through selecting the right service for his or her needs.

An operation through, or related to an API may result in notifications sent to APIs of other systems, or to human users via means such as e-mail or text messages, e.g. for auditing or billing purposes.

Container technologies such as LXC, Docker or Solaris Zones may be used to run a management system, backend clusters or other components, possibly using higher-level orchestration technologies such as Kubernetes or Fleet as known in the art. A management or interface unit (e.g., a Consumable Management System (CMS) as described herein) may be deployed in enterprise cloud, in a public cloud or in both clouds. It will be understood that instances of a CMS described herein may be deployed in any cloud as known in the art. In some embodiments, a management or interface unit may be connected to an enterprise or public network where endpoint servers reside or where management backend clusters reside through a proxy server as known in the art.

Reference is now made to FIG. 2, which is a schematic illustration of a system and method according to one embodiment of the present invention. As seen in FIG. 2, one or more users, as shown by block 2.1, may operate or interface, as shown by arrow 2.7, a web browser such as Google Chrome (shown by block 2.2) to access and operate, as shown by arrow 2.8, via a network protocol such as HTTPS (2.8) one or more CMS servers as shown by block 2.4, in order to consume a management tool used to manage an endpoint server as shown by block 2.3.

As described herein, management services and operations related to aspects such as, but not limited to, backup, monitoring, configuration and security may be provided to a user, by CMS 2.4. For example and as further described, in order to provide management services, CMS 2.4 may use (or consume) management tools provided by 3^{rd} party vendors (e.g., 3^{rd party} vendors such as HP, Microsoft and Symantec as described herein). For example, with respect to backup, CMS 2.4 may use a 3^{rd} party management tool to provide to a user with a listing of past backup images, trigger a new backup, create a new backup image or perform a recovery procedure. Accordingly, a user may simply request (in a management service request as described herein) a backup operation for an endpoint server without having to know anything about the endpoint server (e.g., the operating system) nor having to know or deal with other aspects such as which management tool is actually used to provide the service.

In another case, CMS 2.4 may provide a monitoring management service by using a monitoring tool provided by a 3^{rd} party, for example, a management service may enable viewing information and metrics of an endpoint server. In yet other cases, CMS 2.4 may enable a user to configure an endpoint server without having to actually interact, or deal with, the management tool used to perform the configuration. For example, in response to a management service request, CMS 2.4 may execute a 3^{rd} party management tool to change a configuration of an endpoint server, e.g., change the endpoint server's time zone or install a new application on the endpoint server. In yet other cases, CMS 2.4 may, in response to a management service request, run an anti-virus scan, accordingly, a user may request CMS 2.4, using a management service request, to scan an endpoint server for viruses without the user having to know which antivirus application is used, how to install the antivirus application, what version of the antivirus application should be used, how to configure the antivirus application, etc.

A management tool may be composed of one or more backend cluster servers, shown by block 2.16, running proprietary software of the management tool shown by block 2.5. In addition, the management tool may be composed of one or more software agents shown by block 2.6, which may be installed on each of the managed endpoint servers 2.3. The agent software (shown by block 2.6) and backend cluster software 2.5 may communicate with one another as shown by arrow 2.11, through various network protocols such as HTTPS. Communication protocols may vary between different management tools and different backend servers.

As shown, CMS server 2.4 may automatically, and transparently to the user, cause the creation of one or more management tool backend cluster servers 2.16, by means of making a request to provision them, as shown by arrow 2.13, from one or more servers composing a virtual computing service (shown by block 2.14). For example, servers composing a virtual computing service may be servers such as Amazon Elastic Compute Cloud or VMWare vCenter. After the virtual computing service servers 2.14 have created the needed servers (as shown by arrow 2.15), the CMS server 2.4 may connect to, or communicate with, the backend servers (as shown by arrow 2.16) via network protocols such as SSH, in order to install, wire together and configure the management tool backend cluster software 2.5.

In some embodiments, a CMS 2.4 (that may include one or more servers or computers) may communicate with endpoint server (as shown by arrow 2.12) via communication protocols such as SSH, in order to install and configure management tool agent 2.6 and/or connect management tool agent 2.6 to the management tool backend cluster servers 2.16. After a management tool agent 2.6 and backend 2.5 have been configured and connected to one another, user 2.1 may initiate management operations such as backing up of a hard drive.

In some embodiments, initiating management operations is done by the user 2.1, e.g., using a web browser 2.2, to make a direct request for the operation from CMS 2.4, without the user being directly in contact with the backend cluster servers 2.16.

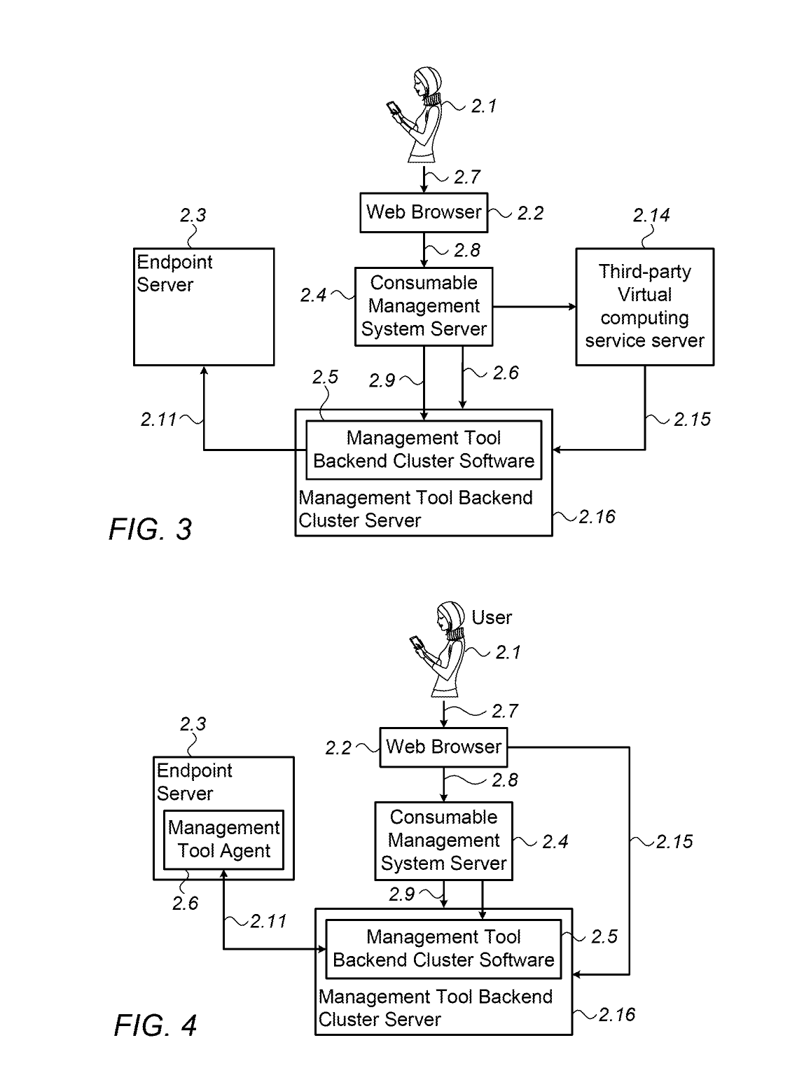

Reference is now made to FIG. 3, which is a high level block diagram of an exemplary system and method according to some embodiments of the present invention. In some embodiments or cases, a management tool being made consumable as a service does not include an agent component that needs to be installed on each endpoint server. An example of such a service is the Nagios monitoring tool when used in “agentless” mode. In such a case, CMS 2.4 may operate in a similar manner to that described with reference to FIG. 2 above, except that CMS 2.4 may not install and configure an agent on the endpoint server.

Reference is now made to FIG. 4, which is a high level block diagram of an exemplary system and method according to some embodiments of the present invention. As shown by arrow 2.7, in order to initiate a management operation such as back up a disk on an endpoint server, user 2.1 may send a request (as shown by arrow 2.8), e.g., using web browser 2.2, to the CMS 2.4, to receive a reference to a user interface console. CMS 2.4 may send back (as shown by arrow 2.8) to the web browser a reference, such as a Universal Resource Locator (URL), denoting the location or address of a backend cluster. A URL may be used by the browser through redirection or through being embedded in a user interface provided by the CMS. The user may then use the web browser to directly use the user interface offered by the backend cluster software 2.5 to run management operations. In some embodiments, the same ability for the user to initiate a management task is provided by the user making a request through the web browser to the CMS, and the CMS directly operating an API or a UI of the management tool backend cluster. In some embodiments, multiple management tools with similar functionality, such as two backup tools, can be operated by users through the same API or UI provided by a CMS.

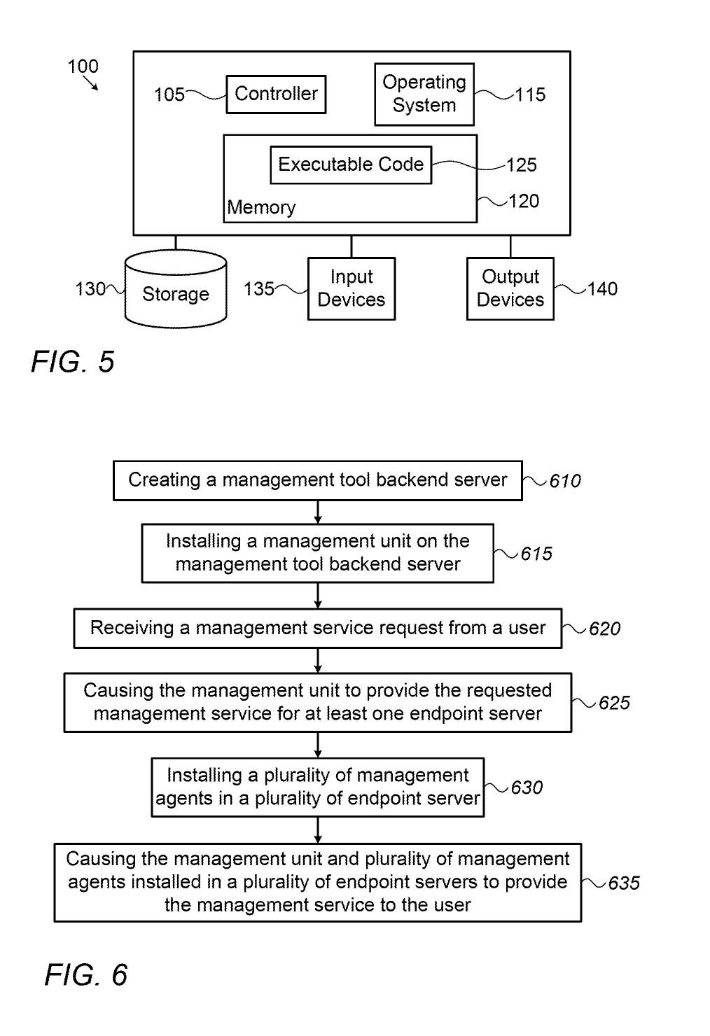

Reference is made to FIG. 5, which shows a high level block diagram of an exemplary computing device according to some embodiments of the present invention. Computing device 100 may include a controller 105 that may be, for example, a central processing unit processor (CPU), a chip or any suitable computing or computational device, an operating system 115, a memory 120, an executable code 125, a storage 130, input devices 135 and output devices 140. Controller 105 may be configured to carry out methods described herein, and/or to execute or act as the various modules, units, etc. More than one computing device 100 may be included, and one or more computing devices 100 may act as the various components, for example the components such as management or interface unit 2.4 shown in FIG. 2. For example, a consumable management system server described herein may be, or may include components of, computing device 100. For example, by executing executable code 125 stored in memory 120, controller 105 may be configured to carry out a method of automating IT operations as described herein. For example, controller 105 may be configured to create a management tool backend server, install a management unit on the management tool backend server, receive a management service request from a user and cause the management unit to provide the management service to the user. Controller 105 may be configured to install a plurality of management agents in one or more endpoint servers, connect the installed management agents with a management tool backend server and cause the management tool backend server and agents to provide a service as described herein.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or enabling software programs or other modules or units to communicate. Operating system 115 may be a commercial operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

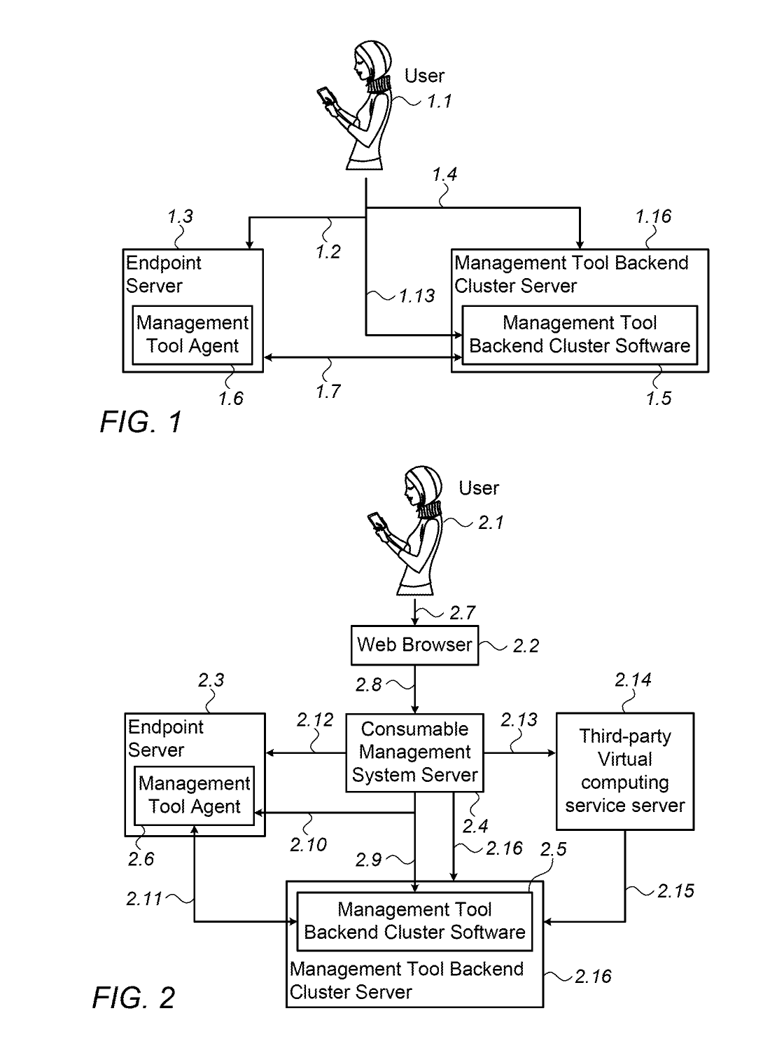

Executable code 125 may be any executable code, e.g., an application, a program, a process, task or script. Executable code 125 may be executed by controller 105 possibly under control of operating system 115. For example, executable code 125 may be an application that automates IT operations by deploying infrastructure and providing management services as further described herein. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein. For example, units or modules described herein (e.g., CMS 2.4) may be, or may include, controller 105, memory 120 and executable code 125.

Storage 130 may be or may include, for example, a hard disk drive, a floppy disk drive, a Compact Disk (CD) drive, a CD-Recordable (CD-R) drive, a Blu-ray disk (BD), a universal serial bus (USB) device or other suitable removable and/or fixed storage unit. Content may be stored in storage 130 and may be loaded from storage 130 into memory 120 where it may be processed by controller 105. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays or monitors, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a printer, a universal serial bus (USB) device or external hard drive may be included in input devices 135 and/or output devices 140.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105.

Some embodiments may be provided in a computer program product that may include a non-transitory machine-readable medium, stored thereon instructions, which may be used to program a computer, controller, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more devices such as computing device 100.

Reference is made to FIG. 6, which is a block diagram of an exemplary method or flow according to some embodiments of the invention. As shown by block 610, a management tool backend server may be created. For example, using services provided by 3^{rd} party virtual computing service server 2.13 as shown in FIG. 2, CMS 2.4 may create, or cause creation of, management tool backend server 2.16 as described herein. As shown by block 615, a management unit may be installed on a management tool backend server. For example, CMS 2.4 may install a management unit, e.g., management tool backend cluster software 2.5, on management tool backend server 2.16. As shown by block 620, a request for a service may be received. For example, using browser 2.2., a user may request a management service from CMS 2.4 as described. As shown by block 625, a management unit may be caused to provide a management service for at least one endpoint server. For example, a management service requested as shown by block 620 may be or may include a request for a backup of endpoint server 2.3, a monitoring service or a service related to security as known in the art.

As shown by block 630, a plurality of management agents may be installed in one or more endpoint servers. For example, if a service can be provided without using any agents (e.g., in agentless mode as described with reference to blocks 610 through 625) then no agents are installed. In some embodiments, CMS 2.4 may install a management tool backend server and/or management agents on demand, as required, or when required. For example, upon receiving a request for a management service, CMS 2.4 may create a management tool backend server as described and may further install one or more management agents on one or more endpoint servers. For example, if a request for a management service (e.g., backup, monitoring or scan for viruses) for endpoint server 2.3 is received by CMS 2.4 before management tool backend server 2.16 is created, CMS 2.4 may create management tool backend server 2.16 as described with reference to block 610, install management tool backend cluster software 2.5 (a management unit) on management tool backend server 2.16 and may further install management agent 2.6 on endpoint server 2.3. Accordingly, facilitating or enabling providing a service for an endpoint server may be fully automated and may be done without intervention of a user who may only be required to request a management service.

As shown by block 635, a management unit and a plurality of management agents installed in a plurality of endpoint servers may be caused to provide a management service. For example, CMS 2.4 may command management tool backend cluster software 2.5 to provide a management service. To provide a management service, a management unit (e.g., management tool backend cluster software 2.5) may interact with one or more management agents and cause the management agents to perform tasks on endpoint servers.

Any number of management tool backend servers may be created. For example, to provide management services for a plurality of endpoint servers, CMS 2.4 may create a plurality of management tool backend servers as described and may cause at least some of the plurality of management tool backend servers and optionally, a plurality of management agents on some of the endpoint servers to provide a management service.

CMS 2.4 may install, create or chose to use a management tool backend server based on various considerations. For example, CMS 2.4 may create a management tool backend server, or select from a plurality of management tool backend servers to use a specific management tool backend server based on a cost, an attribute of an endpoint server, a network topology and a geographic location. A cost considered in selecting or creating a management tool backend server may be related to the cost of using infrastructure (e.g., using services provided by virtual computing service 2.14, for example, the cost of maintaining a virtual server or machine). For example, if two similar management tool backend servers can be used to provide a management service for an endpoint server (e.g., two similar management tool backend servers on two different virtual machines) then CMS 2.4 may select to create or use the cheaper or less costly management tool backend server.

Creating, or selecting to use, a management tool backend server based on an attribute of an endpoint server may be based on any attribute of the endpoint server. For example, the location of the endpoint server may be considered and the management tool backend server may be created or selected such that it is as geographically closest to the endpoint server. Another attribute may be the type of services needed for the endpoint server. For example, if backup is required for the endpoint server then CMS 2.4 may create or select a management tool backend server with the capacity to store large amounts of data. Accordingly, both attributes of a management tool backend server and an endpoint server may be taken into account by CMS 2.4 when matching a management tool backend server with an endpoint server. Matching a management tool backend server with an endpoint server as referred to herein may include configuring the management tool backend server to collaborate with the endpoint server in providing management services as described herein.

Creating, or selecting to use, a management tool backend server for an endpoint server may be based on a network topology. For example, if the endpoint server is behind, or protected by, a firewall then the management tool backend server may be installed such that the firewall permits or enables the management tool backend server to communicate with the endpoint server, for example, the management tool backend server may be created or installed behind the same firewall as known in the art. Creating, or selecting to use, a management tool backend server for an endpoint server may be based on a geographic location of the endpoint server and/or a geographic location of the management tool backend server. For example, to provide a management service for an endpoint server located in an organization or a data center, a management tool backend server may be created in the data center such that it is as geographically close as possible to the endpoint server thus possibly improving performance and cost.

As described herein, a system and method according to some embodiments of the invention may cause two or more different management tools on, or executed by, respective two or more different management tool backend servers to provide a single management service. For example, a management service requested in a management service request as described with reference to block 620 may be provided by executing or using two or more management tools provided by different vendors of management tools.

For example, for one organization, CMS 2.4 may create two management tool backend servers that may provide a backup management service for two different endpoints servers of the organization. Assuming a first one of the two endpoint servers is a Linux machine and the second endpoint server is a Windows machine as known in the art, CMS 2.4 may install or configure different tools and agents for backup on the two endpoint servers, e.g., Linux and Windows agents and management tools. Upon receiving, from a user in the organization and by CMS 2.4, a request for a management service that includes a backup request, CMS 2.4 may cause the two management tool backend servers to execute the respective two backup tools on the two endpoint servers such that a backup of data of the organization is performed. Accordingly, a user may only need to request a backup (or other management service) and a system and method according to embodiments of the invention may cause the underlying infrastructure to provide the service, relieving the user from having to deal with various management tools.

CMS 2.4 may provide a user with a list or other presentation of management services that may be provided by a system and method according to embodiments of the invention. For example, CMS 2.4 may detect, identify or determine which management services can, or should be provided for an endpoint server based on at least one of: a related management tool backend server, a tag of the endpoint server, a function performed by the endpoint server, a cost, a geographic location, a network topology and an operating system type.

For example, a management tool backend server related to an endpoint server may be configured, e.g., by CMS 2.4 as described, to provide a set of management services for the endpoint server. CMS 2.4 may record the set of services provided by a management tool backend server for a specific endpoint server and may present the set to a user. Accordingly, if a user or owner of an endpoint server wants to know what management services can be provided for his or her endpoints server, the user may send a request to CMS 2.4 and receive a list of services that can be provided for the endpoint server.

A list or set of management services for an endpoint server may be created based on a tag of the endpoint server. Tags associated with endpoint servers are known in the art. Generally a tag identifies or indicates attributes of a server, e.g., a tag may indicate which business application the server is part of (finance, inventory management, human resources management, etc.) or what the server is used for within this application (database, web server, etc.). CMS 2.4 may configure management services for an endpoint server based on a tag of the endpoint server. For example, a higher-end, more feature-rich backup management service may be required for a business application that needs to conform to a certain regulatory standard such as the “Public Company Accounting Reform and Investor Protection Act” of 2002 (known in the art as Sarbanes-Oxley). Accordingly, management services provided by an embodiment may be automatically configured and provided based on a tag, or a function performed by, an endpoint server.

A list or set of management services for an endpoint server may be created, e.g., by CMS 2.4, based on a cost. For example, a cost of storage may affect a cost of a backup. Accordingly, CMS 2.4 may include or exclude a backup management service for an endpoint server based on the cost of a backup data in the endpoint server. In another example, the cost associated with the management tool software may differ between management tools. In some embodiments, a list or set of management services may include a cost estimate enabling a user to select management services for an endpoint based on their cost.

A list or set of management services for an endpoint server may be created, e.g., by CMS 2.4, based on a geographic location and/or a network topology. For example, if a management tool backend server cannot be created or configured such that it can communicate with an endpoint server (e.g., the endpoint server is in a closed or private network) then CMS 2.4 may inform the user that the list of management services for the endpoint server is empty. In another case, if, due to a geographic location of the endpoint server or due to a network topology, network throughput or bandwidth between the endpoint server and the relevant management tool backend server is limited, then management services that require considerable network throughput (e.g., backup) may be omitted from a list of management services for the endpoint server while other management services that require less network bandwidth (e.g., monitoring) may be provided. In yet other cases, CMS 2.4 may configure management services based on an operating system of an endpoint server. For example, the set of management tools available for a given operating system may dictate the set of management services provided as described herein. For example, if management tools or agents for monitoring are available for a Red Hat Linux operating system but are unavailable for an Ubuntu operating system then a list of management services for two endpoint servers, one running Red Hat Linux and the other running Ubuntu will only include a monitoring management service for the Red Hat Linux endpoint server.

Accordingly, a set of management services for an endpoint server may be defined based on any considerations, e.g., a cost, a geographic location, a network topology and an operating system type and list of management services for an endpoint server presented to a user may be created based on considerations as described.

CMS 2.4 may, periodically or upon receiving a request from a user, determine a status of at least one of: a management tool backend server, a management unit, a management agent and an endpoint server. For example, CMS 2.4 may send a message to management tool backend server 2.16 requesting management tool backend server 2.16 to report its status, e.g., report errors occurred when providing a management service, report malfunctioning units etc. In a similar manner, CMS 2.4 may check the status of backend cluster software 2.5 (e.g., by sending a message or request to backend cluster software 2.5) or CMS 2.4 may check the status of management tool agent 2.6. Additionally or alternatively, management tool backend server 2.16 or backend cluster software 2.5 may check the status of management tool agent 2.6 and report the status to CMS 2.4. According to some embodiments of the invention, determining a status of a unit, e.g., status of a management tool backend server, an agent or a management unit may include executing built-in or customized health check scripts or plugins as known in the art.

CMS 2.4 may apply a filter, rule, threshold or criterion to a status report received from a component in a system. CMS 2.4 may process a status report using a filter, rule, threshold or criterion to produce a result. Based on a result of processing a status report or a result of applying a criterion or rule to the status result, CMS 2.4 may perform one or more actions. For example, based on a status of an endpoint server, an agent or a unit, CMS 2.4 may fix a malfunctioning unit, restart an agent, replace a unit and/or notify a user that an event occurred. For example, if a status report received from management tool backend server 2.16 indicates that backend cluster software 2.5 is unresponsive (e.g., backend cluster software 2.5 has crashed as known in the art) then CMS 2.4 may restart backend cluster software 2.5 on management tool backend server 2.16 and may further report the event to a user. Reporting to a user may include sending an electronic mail, notifying a selected third-party system such as Splunk via protocols such as Syslog, sending a text message and the like.

As described herein, CMS 2.4 may create a plurality of management tool backend servers. When two or more management tool backend servers are included in a system, CMS 2.4 may be configured to provide or perform load balancing. For example, CMS 2.4 may balance a load between a plurality of management tool backend servers. For example, a number of management tool backend servers may provide a backup management service for a number of endpoint servers of an organization and CMS 2.4 may distribute the backup service between the management tool backend servers such that the load on each of the management tool backend servers is optimal, e.g., substantially equal or is divided according to the capabilities of the management tool backend servers.

CMS 2.4 may be configured to replicate or migrate, a management unit of a first management tool backend server on or to, a second management tool backend server. For example, CMS 2.4 may copy backend cluster software 2.5 (and any configuration files or other objects) from management tool backend server 2.16 to another management tool backend server and thus cause a replication or migration of backend cluster software 2.5. Accordingly, services provided by a first system that includes management tool backend server as described may be quickly and efficiently provided by a second system or installation.

CMS may configure or re-configure a system based on input from a user. For example, CMS 2.4 may command or cause backend cluster software 2.5 to apply a change to an attribute of the management service based on input from a user. For example, a user may request a backup management service to be performed every 24 hours and may later request to change the service such that the backup is done every 12 hours. In such case, CMS 2.4 may communicate with backend cluster software 2.5, request a modification of the backup management service and backend cluster software 2.5 may update information or configuration of the management service and further provide the backup management service according to the new configuration (e.g., perform a backup every 12 hours instead of every 24 hours).

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A computer-implemented method of providing a service, the method comprising:
creating a management tool backend server;
installing a management unit on the management tool backend server;
receiving a management service request from a user; and
causing the management unit and a plurality of management agents installed in a plurality of endpoint servers to provide the management service to the user.

2. The method of claim 1, comprising:
creating a plurality of management tool backend servers by a management interface unit; and
causing, by the management interface unit, at least some of the plurality of management tool backend servers and the plurality of management agents to provide the management service to the user.

3. The method of claim 1, comprising:
causing at least two different management tools on respective two different management tool backend servers to provide a single management service requested in management service requests.

4. The method of claim 1, comprising executing the management agents within containers on the endpoint servers.

5. The method of claim 1, creating, or selecting from a plurality of management tool backend servers, a management tool backend server to provide the management service, based on at least one of: a cost, an attribute of an endpoint server, a network topology and a geographic location.

6. The method of claim 1, comprising:
determining which management services may be provided for an endpoint server based on at least one of: a related management tool backend server, a tag of the endpoint server, a function performed by the endpoint server, a cost, a geographic location, a network topology and an operating system type;
presenting a list of management services that can be provided for the endpoint server.

7. The method of claim 1, wherein the management tool backend server is created upon receiving a management service request.

8. The method of claim 1, comprising:
periodically determining a status of at least one of: the management tool backend server, the management unit, the management agents and the endpoint servers; and
based on a criterion applied to the status performing at least one of: fixing a malfunctioning unit, restarting a unit, replacing a unit and notifying a user.

9. The method of claim 1, wherein a unit is configured to balance load between a plurality of management tool backend servers.

10. The method of claim 1, wherein a unit is configured to replicate or migrate the management unit of a first management tool backend server on or to, a second management tool backend server.

11. The method of claim 1, comprising configuring the management unit to apply a change to an attribute of the management service based on input from a user.

12. A method of providing a management service, the method comprising:
creating a management tool backend server;
installing a management unit on the management tool backend server;
receiving a management service request from a user, the request related to at least one endpoint server; and
causing the management unit and the management tool backend server to provide the management service for the at least one endpoint server.

13. The method of claim 12, comprising, causing at least two different management tools on respective two different management tool backend servers to provide a single management service requested in management service requests.

14. The method of claim 12, comprising, creating, or selecting from a plurality of management tool backend servers, a management tool backend server to provide the management service, based on at least one of: a cost, an attribute of an endpoint server, a network topology and a geographic location.

15. The method of claim 12, comprising:
determining which management services may be provided for an endpoint server based on at least one of: a related management tool backend server, a tag of the endpoint server, a function performed by the endpoint server, a cost, a geographic location, a network topology and an operating system type;
presenting a list of management services that can be provided for the endpoint server.

16. The method of claim 12, wherein the management tool backend server is dynamically created upon receiving a management service request.

17. The method of claim 12, comprising:
periodically determining a status of at least one of: the management tool backend server, the management unit and an endpoint server; and
based on a criterion applied to the status, performing at least one of: fixing a malfunctioning unit, restarting a unit, replacing a unit and notifying a user.

18. The method of claim 12, wherein a management unit is configured to do at least one of:
balance load between a plurality of management tool backend servers, replicate or migrate the management unit of a first management tool backend server on or to, a second management tool backend server and apply a change to an attribute of a management service based on input from a user.

19. A system comprising an interface unit, the interface unit configured to:
create a management tool backend server;
install a management unit on the management tool backend server;
receive a management service request, the request related to at least one endpoint server; and
cause the management unit and the management tool backend server to provide the management service for the at least one endpoint server.

20. The system of claim 19, wherein the interface unit is configured to:
install at least on management agent on the at least one endpoint server; and
cause the management unit and the one or more management agents to provide the management service.
